(19) United States
(12) Patent Application Publication
(10) Pub. No.: US 2021/0311684 A1
(43) Pub. Date: Oct. 7, 2021

(54) HOLDING DEVICE FOR VIDEO WALLS

(71) Applicant: Reintechnik GmbH, Dornbirn (AT)

(72) Inventor: Christoph NUSSBAUMER, Andelsbuch (AT)

(73) Assignee: Reintechnik GmbH, Dornbirn (AT)

(21) Appl. No.: 17/267,075

(22) PCT Filed: Aug. 6, 2019
(86) PCT No.: PCT/EP2019/071124

§ 371 Date: Feb. 9, 2021

(30) Foreign Application Priority Data
Aug. 14, 2018 (AT) A 246/2018

(51) Int. Cl. G06F 3/14; F16M 11/04; F16M 11/18; F16M 11/38; F16M 13/02

(52) U.S. Cl. CPC G06F 3/1446; F16M 11/048; F16M 2200/061; F16M 11/38; F16M 13/022; F16M 11/18

(57) ABSTRACT

In a holding device for video walls, having a plurality of screen holders (4), each one used to hold a screen (1) of the video wall, each screen holder (4) can be moved between a retracted working position and an extended service position by an electric motor (25). Each screen holder (4) includes an optical sensor (29) with a light source (30) and a photoelectric receiver (31), wherein the movement of the screen holder (4) from the retracted working position into the extended service position can be triggered by a reflective lamina (32) that can be detected by the optical sensor (29) of the screen holder (4).

### TECHNICAL FIELD

The invention relates to a holding device for video walls, having a plurality of screen holders for holding in each case one screen of the video wall, wherein a respective screen holder is movable, by a drive apparatus having an electric motor, between a retracted work position and an extended maintenance position.

### BACKGROUND

Video walls having a plurality of rows of screens arranged one next to the other and a plurality of columns of screens arranged one above the other are known. The individual screens (=monitors) have the narrowest possible frames and the narrowest possible gaps located between them so that the impression of a contiguous large image can be achieved. Such video walls are also referred to as screen walls. A respective screen of the video wall is attached to a respectively associated screen holder, which is attached to a wall (or to a framework). In addition, a video wall typically has a lateral boundary. The latter can be formed by a frame mounted to the wall to which the video wall is attached. In another possible embodiment, the wall has a recess in which the screen holders are arranged, wherein the front sides of the screens mounted to the screen holders typically terminate flush with the periphery of the recess. The side walls of the recess in the wall then form the lateral boundary of the video wall. The slits between the lateral boundary of the video wall and the screens adjoining the lateral boundary are preferably also narrow.

In order to allow maintenance and/or an exchange of a respective screen, the screen holders can typically be moved between a retracted work position, in which the video wall is operated, and an extended maintenance position, in which the rear side of the relevant screen is accessible and the relevant screen can be removed from the screen holder, if necessary. A conventional embodiment here makes provision for two scissors mechanisms to be present between a mounting plate for mounting the screen holder to the wall (or to the framework) and a carrying unit to which the screen is attached. A spring is used for extending the screen holder from the work position into the maintenance position, wherein a locking part blocking the extension can be released by pushing in the screen and thus the screen holder. A holding device for video walls having such screen holders is disclosed in US 2016/0143440 A1. One drawback of said already known screen holders is that pushing in the screen attached to the screen holder may result in pixels of the screen being damaged.

US 2016/0143440 A1 also mentions a holding device for video walls in which the screen holders are extended using an electric motor and a gear arrangement, wherein the electric motor is actuated via remote control. Such a system is, however, complex in particular regarding the remote control that is required, wherein the shielding effect due to the screens also constitutes a problem that might have, for example, a disadvantageous effect on controlling via Bluetooth.

US 2009/0032656 A1 discloses a screen holder that is movable by way of a motor. A sensor having a transmitting part and a receiving part is provided, which interact with the opening of a spring-mounted part to detect a collision when the screen holder is retracted, so that the actuator can consequently be deactivated.

### SUMMARY

It is an object of the invention to provide an advantageous and easily operable holding device of the type mentioned in the introductory part. This is achieved by a holding device having one or more of the features disclosed herein.

In the holding device according to the invention, a respective one of the screen holders has an optical sensor with a light source and a photoelectric receiver. The movement of the screen holder from its retracted work position into its extended maintenance position by way of the electric motor is triggered by a reflector plate that is detectable by the optical sensor of the holder. The use of a sufficiently thin reflector plate makes it possible to insert the latter through the gap between two screens mounted to screen holders or the gap between a screen mounted to one of the screen holders and a peripheral boundary of the video wall, as a result of which it passes into the light beam from the light source and reflects said light beam back onto the photoelectric receiver to trigger the extension of the screen holder.

Due to the invention, a highly simple operation becomes possible for extending the screen holder for a desired screen into the maintenance position, wherein the screen is spared as much as possible.

The reflector plate can advantageously have a thickness of less than 2 mm, preferably less than 1 mm.

Optical sensors and fixedly mounted reflectors are typically used in the case of photoelectric sensors. These sense the interruption of the light beam of the light source of the optical sensors so as to detect in this way movable objects in automatic devices in a contactless manner.

For the movement between the retracted work position and the extended maintenance position, a respective one of the screen holders can advantageously have at least one scissors mechanism, preferably a first and a second scissors mechanism. In this case, the first scissors levers of the first and second scissors mechanisms are advantageously connected to one another via at least one first connecting rod and the second scissors levers of the first and second scissors mechanisms are connected to one another via at least one second connecting rod. In this way, great stability of the screen holder can be achieved.

In an advantageous embodiment of the invention, a spring is arranged in the force transmission path of the drive apparatus. If a collision should occur while retracting the screen holder from the extended maintenance position into the retracted work position, in particular a collision of the screen held by the screen holder with an adjacent screen (e.g. owing to a misalignment of the screens), said spring is deformed. Furthermore, a sensor is provided, which is able to capture such a deformation of the spring, in particular by capturing a displacement of one of the two parts between which the spring acts with respect to the other one of said two parts, as a result of which a collision can be detected. As a result, the retraction can be stopped, or the screen holder can be extended again, at least a bit. Analogously, it is additionally or alternatively possible to provide detection of a collision while the screen holder is being extended.

A further aspect of the invention relates to a video wall having a plurality of screens that are surrounded by a lateral boundary and having a holding device for the screens, wherein one screen holder embodied according to the invention is provided for each of the screens and the reflector plate is able to be inserted into the slit between the screen attached to said screen holder and an adjacent screen or the lateral boundary in order to trigger the movement of a respective screen holder from its retracted work position into its extended maintenance position.

A further aspect of the invention relates to a method for moving a screen holder of a holding device for video walls that has a plurality of screen holders for holding in each case one screen of the video wall, wherein a respective screen holder is movable, by an electric motor, between a retracted work position and an extended maintenance position. An electronic controller controlling the electric motor is connected to an optical sensor with a light source and a photoelectric receiver. A reflector plate that is detectable by the optical sensor is inserted into a slit between a screen attached to a respective screen holder and an adjacent screen or a lateral boundary of the video wall in order to trigger the movement of said screen holder.

### BRIEF DESCRIPTION OF THE DRAWINGS

Further advantages and details of the invention will be explained below with reference to the attached drawing, in which:

FIG. 1 shows a video wall in an elevation (the holding device is not visible);

FIG. 2 shows a perspective view of the video wall;

FIG. 3 shows a perspective view similar to FIG. 2, but in which one of the screen holders is extended into the maintenance position;

FIG. 4 shows a section along line AA of FIG. 1;

FIG. 5 shows a section similar to FIG. 4 upon triggering of the extending of one of the screen holders;

FIG. 6 shows the screen holder extended (for the sake of clarity, only the screen holders of the middle column are shown);

FIG. 7 shows an illustration similar to FIG. 6 upon triggering of the retraction of the screen holder;

FIGS. 8 and 9 show an elevation and a side view of one of the screen holders in the retracted state;

FIG. 10 shows a second along the line BB of FIG. 8;

FIGS. 11 and 12 show illustrations similar to those of FIGS. 8 and 9 in the extended state of the screen holder;

FIG. 13 shows a second along the line CC of FIG. 11;

FIGS. 14 and 15 show perspective views obliquely from the front and obliquely from the rear of the screen holder in the retracted state;

FIGS. 16 and 17 show perspective views similar to FIGS. 14 and 15 in the extended state of the screen holder;

FIG. 18 shows a perspective view similar to FIG. 16, wherein parts of the screen holder are shown in an exploded view;

FIGS. 19 and 20 show top views of the screen holder in the retracted and extended states;

FIG. 21 show a schematic illustration of the elements used for retracting and extending the screen holder;

FIG. 22 shows a detail of a perspective view similar to FIG. 17 of a second exemplary embodiment of the invention;

FIG. 23 shows a detail of a section similar to FIG. 13 for said second exemplary embodiment of the invention;

FIG. 24 shows a detail of a perspective view similar to FIG. 17 for a third exemplary embodiment of the invention;

FIG. 25 shows a part of a side view similar to FIG. 12 (but without the optical sensor 29) of said third exemplary embodiment of the invention; and

FIGS. 26 and 27 show illustrations similar to FIGS. 10 and 13 of a fourth exemplary embodiment of the invention.

### DETAILED DESCRIPTION

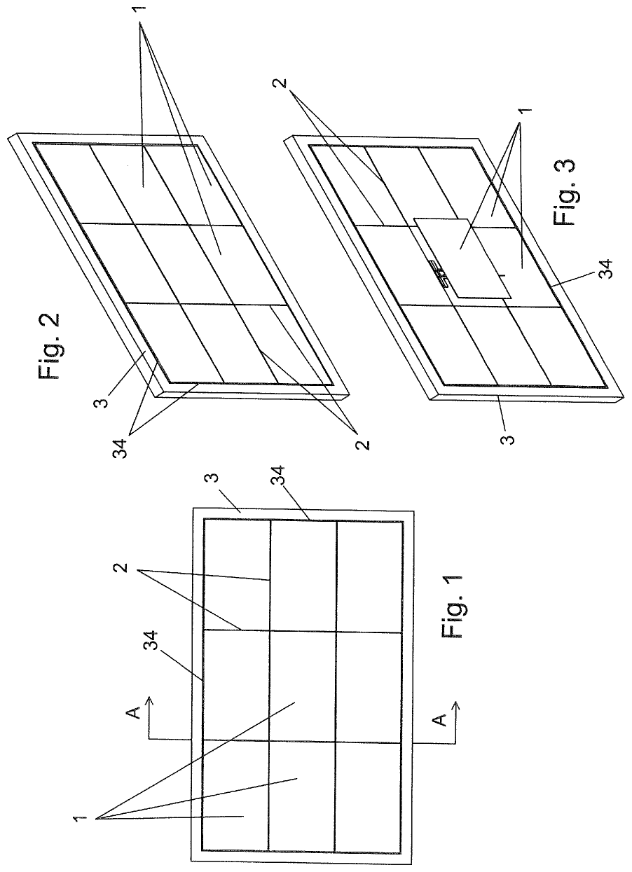

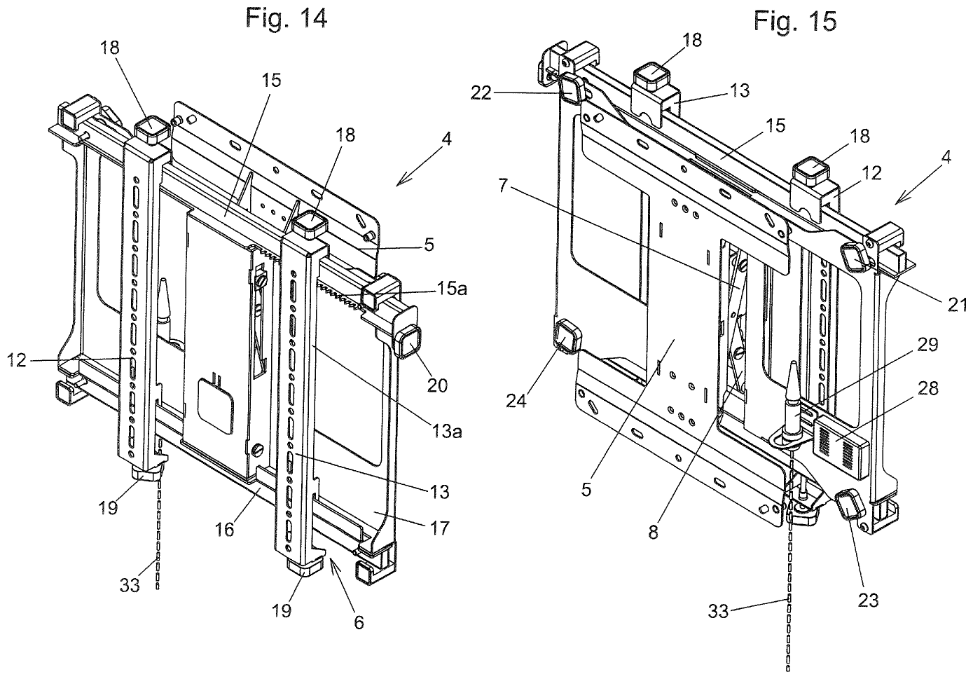

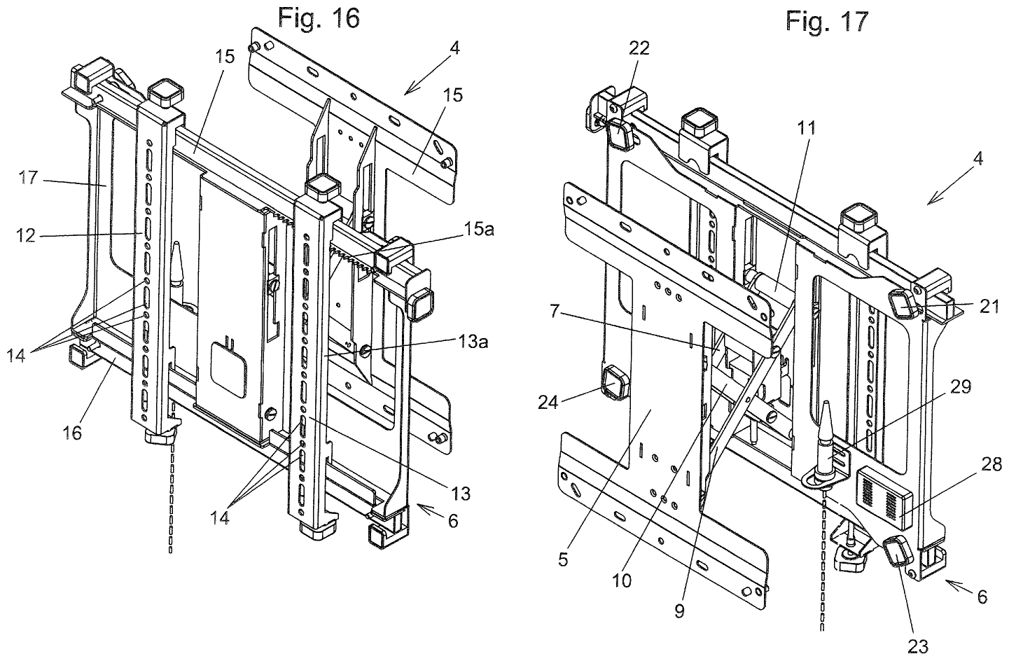

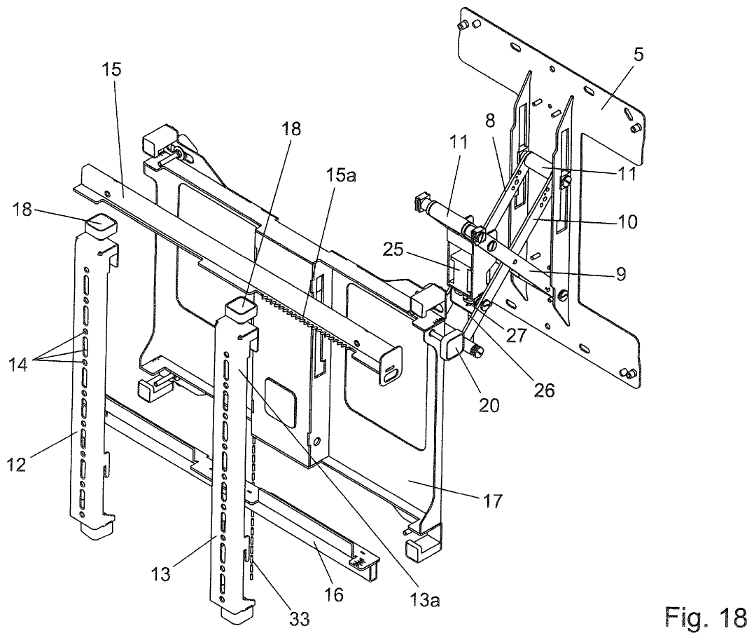

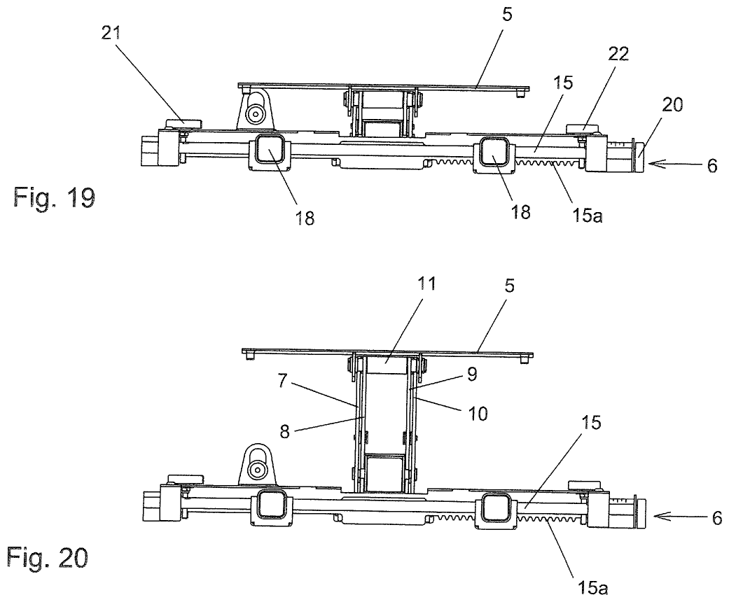

FIGS. 1 to 21 show a first exemplary embodiment of the holding device according to the invention for video walls. The video wall has a plurality of screens 1 that are arranged in rows and columns, or, in other words, in the manner of a matrix. The front sides of the screens 1 lie in a common plane, that is to say they are arranged such that they are flush with one another. Distances between adjacent screens 1 of a row and between adjacent screens 1 of a column are as small as possible so as to disrupt the impression of an overall image illustrated on the video wall as little as possible. The width of the slits 2 between adjacent screens 1 is preferably less than 3 mm.

The screens 1 (=monitors) have outer frames that are as narrow as possible.

A lateral boundary 3 of the video wall, formed by a frame in the exemplary embodiment, extends along the outer peripheries of the outwardly located screens 1. Alternatively, the wall to which the video wall is mounted could also have a recess, and the side walls of that recess could form the lateral boundary of the video wall. The front side of the lateral boundary 3 is preferably flush with the front sides of the screens 1. A slit 34 is located in each case between the periphery of the respective screen 1 and the lateral boundary 3. The width of said slit 34 is preferably less than 5 mm.

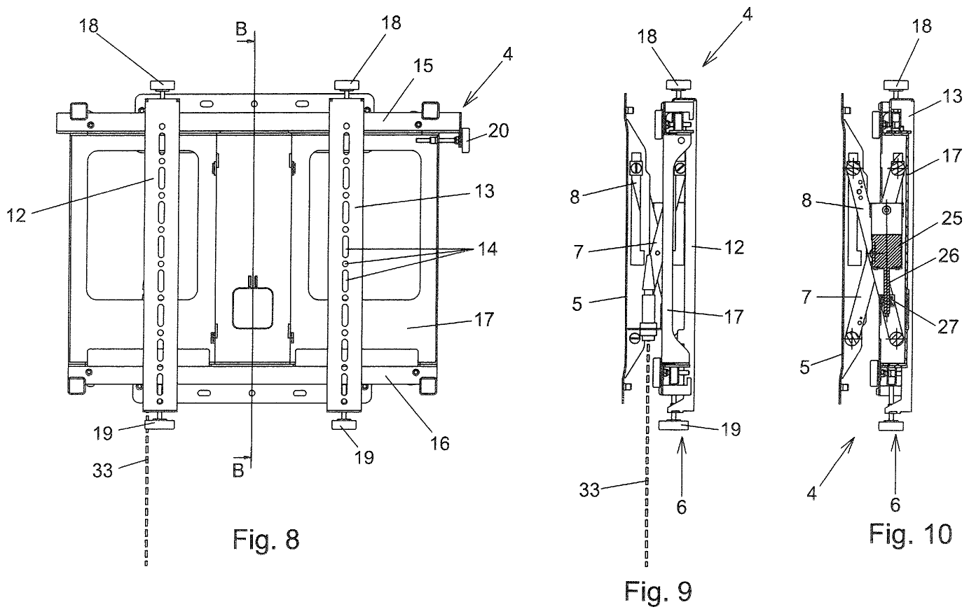

The screens 1 of the video wall are held by a holding device comprising a dedicated screen holder 4 for each of the screens 1. Such a screen holder is illustrated in detail in FIGS. 8 to 20. The screen holders 4 can all have the same design.

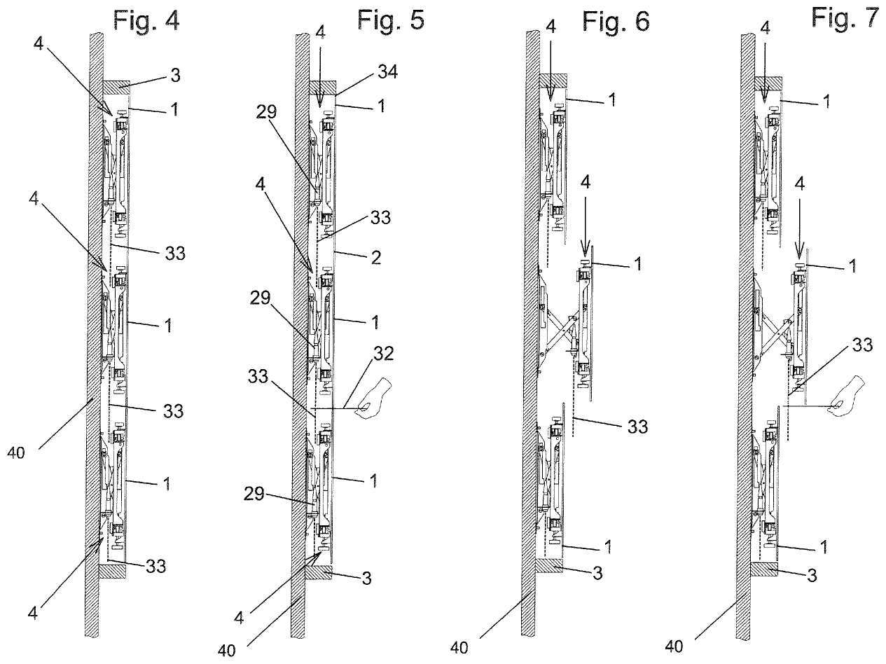

The screen holder 4 has a mounting plate 5 for attaching the screen holder 4 to the wall 40 (cf. FIGS. 4-7), to which the video wall is to be mounted. Mounting to a framework is also conceivable and possible. The mounting plate 5 is connected to the carrying unit 6 via a lever mechanism. The screen 1 is attachable to the carrying unit 6, wherein there are various possibilities for aligning the screen, as will be explained in more detail further below.

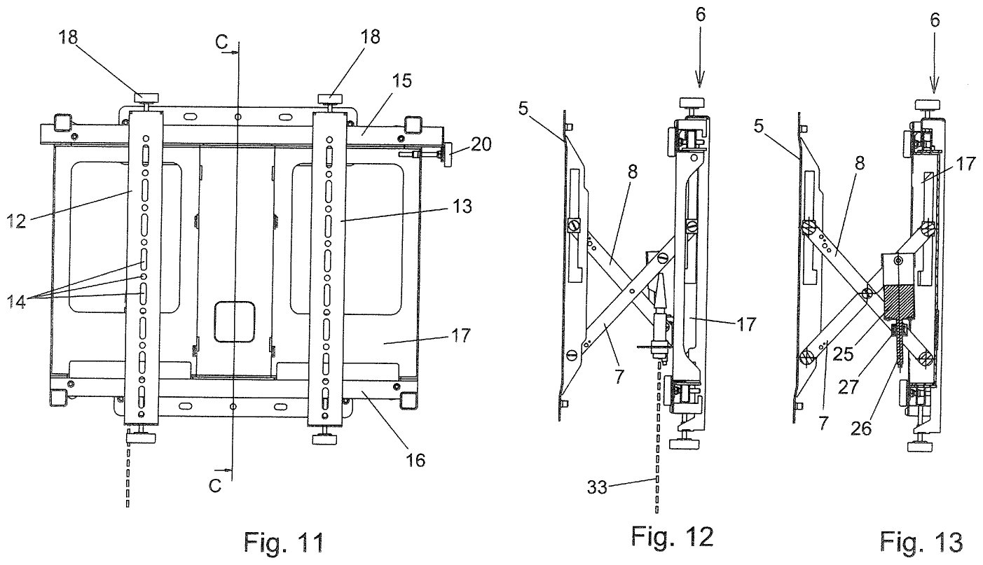

The lever unit, via which the mounting plate 5 is connected to the carrying unit 6, serves for making extending and retracting the screen 1 in a direction at a right angle to the plane of the video wall possible. The screen holder 4 can thus be moved between a retracted work position (FIGS. 8-10, 14, 15 and 19) and an extended maintenance position (FIGS. 11-13, 16, 17 and 20). In the retracted work position, the carrying unit 6, and thus the screen 1, has been moved back such that the front side of the screen 1 lies in one plane with the other screens, cf., in particular, FIGS. 4 and 5. In the extended maintenance position, the carrying unit 6, and thus the screen 1, has been moved forward such that the front side of the screen 1 lies in front of the front sides of the other screens 1, cf., in particular, FIGS. 6 and 7.

The lever apparatus for allowing the movement of the screen holder between the work position and the maintenance position is formed by two scissors mechanisms in the exemplary embodiment. A respective scissors mechanism is formed by first and second scissors levers 7, 8 and 9, 10, which are arranged in the manner of a cross and are pivotably connected to one another at the intersection. The two scissors mechanisms are spaced apart in the axial direction of the parallel pivot axes of the scissors levers 7, 8 and 9, 10. In the exemplary embodiment, the first scissors levers 7, 9 are pivotably connected by their one ends to the mounting plate 5, wherein the pivot pin is non-displaceable with respect to the mounting plate 5. The other ends of the first scissors levers 7, 9 are connected to the carrying unit 6 so as to be pivotable about pins that are displaceable with respect to the carrying unit 6 (in a direction parallel to the plane of the video wall). The carrying unit 6 has corresponding slots for this purpose. The second scissors levers 8, 10 are connected by their one ends to the carrying unit 6 so as to be pivotable about pins that are non-displaceable with respect to the carrying unit 6, and the other ends of the second scissors levers 8, 10 are connected to the mounting plate 5 such that they are pivotable about pins that are displaceable with respect to the mounting plate 5 (parallel to the plane of the video wall). The mounting plate 5 has corresponding slots for this purpose.

The first scissors levers 7, 9 are connected to each other, just like the second scissors levers 8, 10, by at least one connecting rod 11. Each of the scissors mechanisms 7, 8; 9, 10 is preferably connected by at least two spaced-apart connecting rods 11. In the exemplary embodiment, such a connecting rod 11 is present at each of the pivotable connections with the mounting plate 6 and with the carrying unit 6.

The carrying unit 6 has vertical attachment rods 12, 13 having holes 14, through which the attachment rods 12, 13 can be screwed to the rear side of the screen 1. In the mounted state of the screen holder 4, the vertical attachment rods 12, 13 are connected to horizontal rails 15, 16 of the carrying unit 6, which for their part are attached to a base part 17 of the carrying unit 6. The scissors levers 7, 10 are supported at the base part 17.

For mounting the screen 1 to the screen holder 4, first the vertical attachment rods 12, 13 are screwed to the rear side of the screen 1, as was already mentioned. The attachment rods 12, 13 are suspended at the upper horizontal rail 15 via hook elements. The vertical position of each of the attachment rods 12, 13 can be changed with respect to the upper horizontal rail 15 within an adjustment range using adjustment screws 18. Once the desired heights have been set, the clamp screws 19 can be used to clamp the attachment rods 12, 13 to the lower horizontal rail 16, whereby they are attached to the horizontal rails 15, 16. A tooth system 15a of the upper horizontal rail 15, in which at least one of the attachment rods 12, 13 engages via a side bar 13a, serves for the form-fitting locking against a horizontal displacement.

At least the upper horizontal rail 15 is supported so as to be axially displaceable in the horizontal direction with respect to the base part 17. A horizontal movement in the axial direction of the upper horizontal rail 15 is made possible by the adjustment screw 20 within an adjustment range. Either the lower horizontal rail 16 is likewise horizontally displaceable with respect to the base part 17 or the horizontal setting by the adjustment screw 20 is accomplished before the attachment rods 12, 13 are fixed by the clamp screws 19, that is to say in the loosened state of the clamp screws 19.

A horizontal movement of the horizontal rails 15, 16 in the direction at a right angle to the longitudinal extent of the horizontal rails 15, 16 with respect to the base part 17 is furthermore possible using adjustment screws 21-24.

In order to extend the screen holder 4 from its work position into its maintenance position and, vice versa, to retract it from its maintenance position into its work position, a drive apparatus having an electric motor 25 is provided. The drive apparatus furthermore has a screw mechanism comprising a spindle 26 and a nut 27, via which the electric motor 25 cooperates with the scissors levers 7-10 via a screw mechanism.

Screw mechanisms, also referred to as leadscrew-type mechanisms, serve for converting a turning movement into a longitudinal movement. By turning a spindle (=screw), a nut held in a non-rotatable manner on the spindle is moved in the longitudinal direction of the spindle or vice versa, i.e. by turning the nut, the spindle that is held in a non-rotatable manner is displaced in its longitudinal direction.

In the exemplary embodiment shown, the electric motor 25 with its housing is pivotably attached to the first scissors levers 7, 9, and the motor shaft forms the spindle 26 of the screw mechanism. The nut 27, which is pivotably connected to the second scissors levers 8, 10, is arranged on the spindle 26.

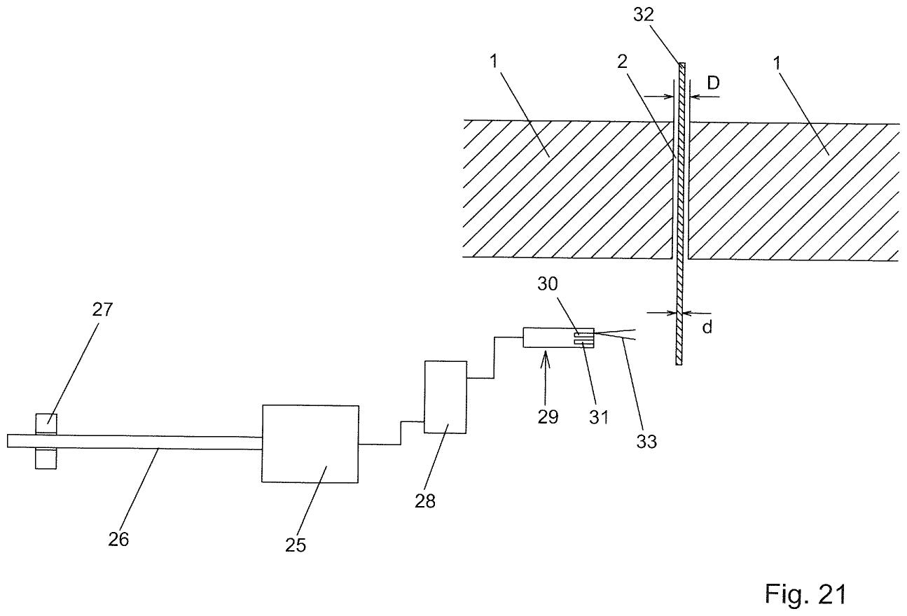

The electronic controller 28 serves for controlling the electric motor 25. Said controller is furthermore electrically connected to an optical sensor 29, cf. the schematic illustration of FIG. 21. The optical sensor 29 has a light source 30, for example a laser diode, and a photoelectric receiver 31, for example a photodiode, a phototransistor or a photoresistor. The light beam 33 from the light source 30 is illustrated schematically as a light cone in FIG. 21 and symbolized in each case by a dashed line in the other Figures.

A reflector plate 32 arranged at a distance in front of the optical sensor 29 is detectable by the optical sensor 29. To ensure reliable triggering and to avoid erroneous triggering, the reflector plate 32 can be a retroreflector. The optical sensor can have a polarization filter.

A movement of the screen holder 4 from the work position into the maintenance position and vice versa is triggered by the electric motor by way of the detection of the reflector plate 32 by the optical sensor 29.

If all screen holders 4 of the holding device are in their work positions and maintenance is intended to be performed on one of the screens 1, a movement of the associated screen holder from its work position into its maintenance position is triggered by the reflector plate 32. In FIG. 5, this is illustrated for a middle screen of the video wall. The reflector plate 32 is inserted through the slit 2 between said screen 1 and an adjacent screen 1 so that it passes into the light beam 33 of the light source 30 of the optical sensor 29 of the screen holder 4 to which the screen that is to be extended is mounted, and is detected by the photoelectric receiver 31 of the optical sensor 29. This is output to the controller 28. The controller then brings about a movement of said screen holder from its work position into its maintenance position by the electric motor 25, cf. FIG. 6. In order to retract the screen 1 again after the maintenance of the screen, that is to say to move the associated screen holder from its maintenance position into its work position, the reflector plate 32 is inserted again into the light beam of the light source 30, cf. FIG. 7. The screen holder is then moved again into its work position by the electric motor, such that the state illustrated in FIG. 4 is attained again.

If the maintenance is to be performed at a peripheral screen 1 of the video wall and the light source 30 of the optical sensor 29 of the screen holder 4 to which the screen 1 is mounted is aimed toward the lateral boundary 3, the reflector plate 32 is inserted into the slit 34 located between said screen 1 and the lateral boundary 3 so as to be detected by the optical sensor 29.

The light beams of the light sources 30 of the optical sensors 29 of all screen holders 4 are advantageously aligned in the same direction, for example downwardly.

The thickness d of the reflector plate 32 is smaller than the widths D of the slits 3 between the screens 1 of the video wall and smaller than the widths of the slits 34 between the screens 1 and the lateral boundary 3 of the video wall.

A dedicated circuit is preferably provided for the electric motor 25, the controller 28 and the optical sensor 29. In that case it is possible to activate said circuit only if a service of at least one of the screens 1 is to be performed.

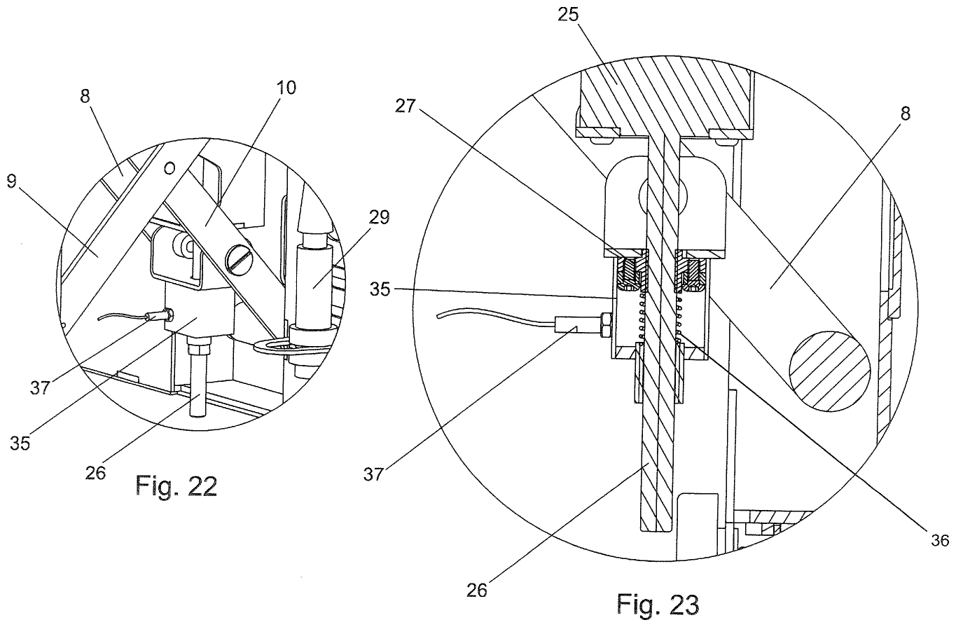

FIGS. 22 and 23 show an advantageous modification of the drive of a respective screen holder 4 by the drive apparatus. The nut 27 arranged on the spindle 26 is here displaceably supported in a transmission part 35, to be specific in the axial direction of the spindle 26. The transmission part 35 is connected pivotably to the second scissors levers 8, 10 of the two scissors mechanisms. A spring 36 is arranged between the transmission part 35 and the nut 27. The spring preloads the nut 27 against the one end of the displacement path with respect to the transmission part 35.

When the screen holder 4 is extended from the retracted work position into the extended maintenance position, the force is transmitted directly from the nut 27 to the transmission part 35, so that the nut 27 remains in any case at the end of the displacement path. During the retraction from the extended maintenance position into the retracted mounting position, the force is transmitted via the spring 36. If the screen holder 4, or the screen 1 mounted thereto, bumps into an obstacle during the retraction, for example into a screen mounted to an adjacent screen holder 4, the nut 27 can be displaced with respect to the transmission part 35 with compression of the spring 36. If this displacement exceeds a specified threshold value, this is detected by a sensor 37. The sensor 37 can be, for example, an inductive or optical sensor. The corresponding signal is output to the controller 28. The latter stops the electric motor 25 and controls it preferably such that it rotates in the opposite direction, with the result that the screen holder 4 is extended again at least a bit, advantageously to an extent corresponding to the displacement of the nut 27 with respect to the transmission part 35, or even up to the fully extended maintenance position.

A collision is in this way cushioned and the retraction of the screen holder 4 is finished before damage occurs. An inverse arrangement, in which the transmission part is pivotably supported on the first scissors levers 7, 9, is of course also conceivable and possible. A further possible variation consists in the electric motor 25 rather than the nut 27 being supported displaceably with respect to a transmission part in the axial direction of the spindle 26 counter to the force of the spring 36, said transmission part being supported pivotably on at least one of the scissors levers 7-10 in a pivotable manner.

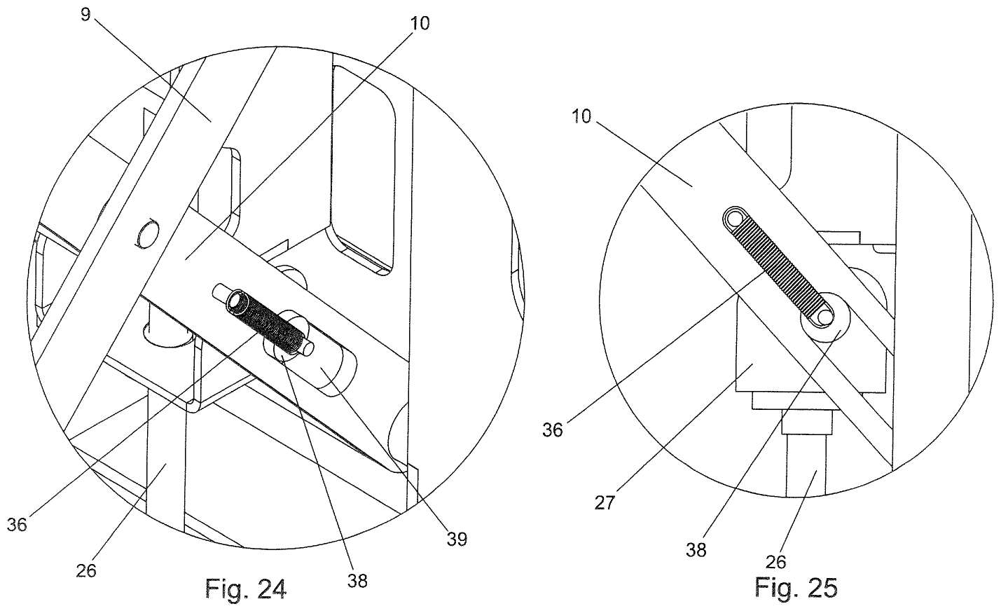

A further possible embodiment with collision protection is illustrated in FIGS. 24, 25. Here, the nut 27 is connected to the second scissors levers 8, 10 via bolts 38 arranged on it (or on a connected part) by virtue of the bolts 38 being displaceably guided in slots 39 extending in the longitudinal direction of the scissors levers 8, 10. A spring 36 that preloads the bolt 38 against the one end of the slot 39 is arranged between the respective bolt 38 and the respective scissors lever 8, 10. When the monitor holder 4 is extended from the retracted work position into the extended maintenance position, the force is transmitted directly from the respective bolt 38 to the respective scissors lever 8, 10. When it is retracted from the maintenance position into the work position, the force is transmitted via the respective spring 36. In the case of a collision, the bolts 38 can be displaced with respect to the slots 39 against the restoring force of the springs 36. If said displacement exceeds a threshold value, this can be captured by a sensor, which is not shown in FIGS. 24, 25 for the sake of simplicity. Capturing by way of the sensor, outputting to the controller 28, and the further actuation of the electric motor 25 by way of the controller can take place in a fully analogous manner as it did in the exemplary embodiment described previously. Likewise, an inversion such that the bolts 28 are arranged in slots 39 of the first scissors levers 7, 9 and the electric motor 25 acts on the second scissors levers 8, 10 is again possible. In addition, a modification is possible such that it is not the nut 27 but the electric motor 25 that cooperates with at least one of the scissors levers 7-10 via at least one bolt that is arranged in a slot and on which a spring located in the force transmission path during the retraction of the screen holder 4 acts.

Collision protection both during the extension and during the retraction is also conceivable and possible. For this purpose, a part, for example the nut in the exemplary embodiment of FIGS. 22, 23 or a respective bolt in the exemplary embodiment according to FIGS. 24, 25, could be held by two springs, one of which is located in the force transmission path during the extension and the other of which is located in the force transmission path during the retraction, in a central position, away from which said part can be displaced in the case of a collision, which is detectably by a respective sensor.

It is also possible that more than one sensor, which captures the state of the spring, for example to detect a complete restoring of the spring, is provided. Different modifications of the exemplary embodiments of the invention shown are conceivable and possible without departing from the scope of the invention, for example regarding the more detailed mechanical embodiment of the screen holders and the type of their movement in order to adapt the alignment of the screen held.

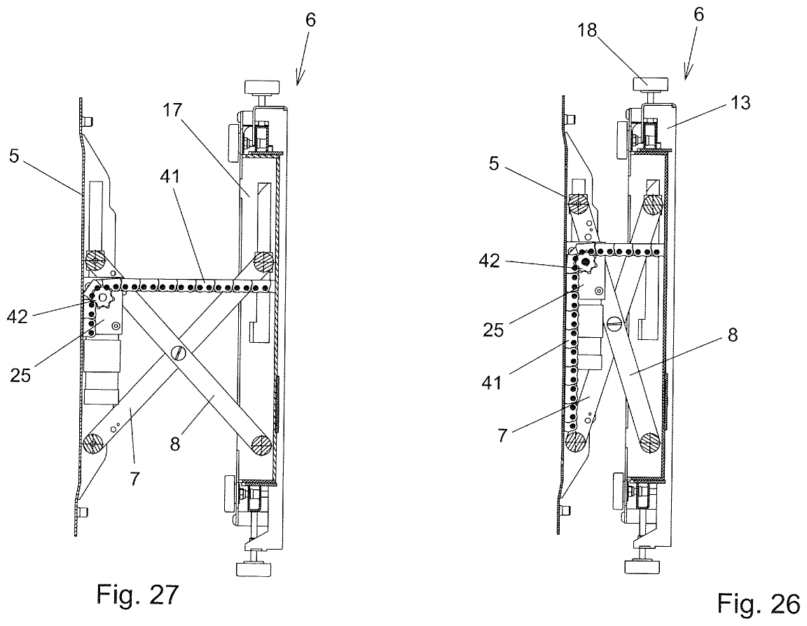

A fourth exemplary embodiment of the invention is illustrated in FIGS. 26 and 27. Aside from the differences that will be described below, the embodiment corresponds to that of the first exemplary embodiment of the invention, and the associated description may be used analogously.

In said fourth exemplary embodiment of the invention, the drive apparatus has a push chain 41, which is driven by the electric motor 25, for moving the screen holder between the retracted work position and the extended maintenance position. The drive apparatus according to this exemplary embodiment could therefore also be referred to as a push chain drive. Push chain drives are known in principle and are characterized by requiring only little installation space.

The electric motor 25, which is driven analogously to the first exemplary embodiment by the electronic controller 28, drives a pinion 42, over which the push chain 41 runs. In the exemplary embodiment shown, the electric motor 25 is rigidly connected to the mounting plate 5, and the push chain 41 is connected rigidly at one end to the carrying unit 6, while its other end is displaceable with respect to the mounting plate 5, in particular is free.

A collision protection in one or both directions could also be realized in this exemplary embodiment, for example analogously to the embodiment described in FIGS. 22 and 23. To this end, the end of the push chain 41 connected to the carrying unit 6 could be rigidly attached to a transmission part that for its part is connected to the carrying unit 6 via at least one spring. In this case, a spring could be located in the force transmission path between the transmission part and the carrying unit 6 for the extension and/or a spring could be located in the transmission path between the transmission part and the carrying unit 6 for the retraction of the screen holder. A displacement of the transmission part with respect to the carrying unit 6 with deformation, in particular compression, of the spring or of one of the springs could here be detected by a sensor or a respective sensor to detect a collision.

In principle, an inverse arrangement could also be provided, in which the electric motor is connected to the carrying unit 6 and one end of the push chain 41 is connected to the mounting plate 5.

A connection of the electric motor 25 to the carrying unit 6 or the mounting plate 5 and of one of the ends of the push chain to one of the scissors levers 7-10 is also conceivable and possible, as is an attachment of the electric motor 25 to one of the scissors levers 7-10 and of one end of the push chain 41 to the carrying unit 6, the mounting plate 5, or the other scissors lever of the respective scissors mechanism.

### LEGEND FOR THE REFERENCE NUMERALS

1 Screen
2 Slit
3 Lateral boundary
4 Screen holder
5 Mounting plate
6 Carrying unit
7 First scissors lever
8 Second scissors lever
9 First scissors lever
10 Second scissors lever
11 Connecting rod
12 Attachment rod
13 Attachment rod
13a Side bar
14 Hole
15 Horizontal rail
15a Tooth system
16 Horizontal rail
17 Base part
18 Adjustment screw
19 Clamp screw
20 Adjustment screw
21 Adjustment screw
22 Adjustment screw
23 Adjustment screw
24 Adjustment screw
25 Electric motor
26 Spindle
27 Nut
28 Controller
29 Optical sensor
30 Light source
31 Photoelectric receiver
32 Reflector plate
33 Light beam
34 Slit
35 Transmission part
36 Spring
37 Sensor
38 Bolt
39 Slot
40 Wall
41 Push chain
42 Pinion

1. A holding device for video walls, the holding device comprising:
a plurality of screen holders configured for holding in each case one screen of the video wall,
a plurality of drive apparatuses, each associated with a respective one of the screen holders for moving the respective screen holder between a retracted work position and an extended maintenance position,
each said drive apparatus having an electric motor,
each respective one of the screen holders has an optical sensor with a light source and a photoelectric receiver, and
a movement of the respective screen holder from the retracted work position into the extended maintenance position is triggerable by a reflector plate that is detectable by the optical sensor of the screen holder.

2. The holding device as claimed in claim 1, wherein each said respective screen holder has at least one scissors mechanism with which the drive apparatus cooperates for movement of said respective screen holder between the work position and the maintenance position.

3. The holding device as claimed in claim 2, wherein each said respective screen holder has a first and a second one of the scissors mechanisms.

4. The holding device as claimed in claim 3, wherein the first and the second scissors mechanisms have in each case first and second scissors levers, wherein the first scissors levers of the first and the second scissors mechanisms are connected to one another via at least one connecting rod and the second scissors levers of the first and the second scissors mechanisms are connected to one another via at least one further connecting rod.

5. The holding device according to claim 1, wherein the drive apparatus further comprises a screw mechanism that is driven by the electric motor.

6. The holding device as claimed in claim 1, wherein the drive apparatus further comprises a push chain that is driven by the electric motor.

7. The holding device as claimed in claim 1, further comprising at least one spring arranged in a force transmission path of the drive apparatus, and a sensor, wherein in case of a collision during retraction of the screen holder from the extended maintenance position into the retracted work position the spring deforms and the sensor is configured to detect the collision.

8. The holding device as claimed in claim 7, wherein a displacement of one of parts between which the spring acts with respect to the other one of said two parts is capturable by the sensor.

9. The holding device as claimed in claim 8, wherein each said respective screen holder has at least one scissors mechanism, which includes scissors levers, with which the drive apparatus cooperates for movement of said respective screen holder between the work position and the maintenance position, and a connection of the drive apparatus to the scissors mechanism is effected via at least one bolt that is displaceable in a slot arranged in one of the scissors levers, and the sensor is configured to detect a displacement of the bolt in the slot that exceeds a specified threshold value.

10. The holding device as claimed in claim 8, wherein each said respective screen holder has at least one scissors mechanism with which the drive apparatus cooperates for movement of said respective screen holder between the work position and the maintenance position, and a part of the drive apparatus is supported in a transmission part, via which the drive apparatus is connected to the scissors mechanism so as to be displaceable counter to a force of the spring, wherein the sensor is configured to detect a displacement of the part of the drive apparatus with respect to the transmission part that exceeds a specified threshold value.

11. The holding device as claimed in claim 1, wherein the reflector plate has a thickness of less than 2 mm.

12. The holding device as claimed in claim 1, wherein the reflector plate is a retroreflector.

13. The holding device as claimed in claim 1, wherein the light source of the optical sensor is a laser diode.

14. A video wall, comprising:
a plurality of screens,
a holding device according to claim 1 for the screens having one said screen holder for each of the screens,
a lateral boundary that surround the screens,
wherein for triggering the movement of one of the screen holders from the work position into the maintenance position, the reflector plate is configured to be insertable into a slit between the screen mounted to said screen holder and an adjacent one of the screens or between the screen mounted to said screen holder and the lateral boundary.

15. A method for moving a screen holder of a holding device for video walls, having a plurality of screen holders for holding in each case one of the screens of the video wall, between a retracted work position and an extended maintenance position by an electric motor, the method comprising:
connecting an electronic controller that is configured to control the electric motor to an optical sensor having a light source and a photoelectric receiver,
and for triggering a movement of one of the screen holders from the work position into the maintenance position, inserting a reflector plate into a slit between the screen that is mounted to said screen holder and an adjacent one of the screens or between the screen that is mounted to said screen holder and a lateral boundary.
